(19) United States
(12) Patent Application Publication
(10) Pub. No.: US 2011/0120378 A1
(43) Pub. Date: May 26, 2011

(54) SYSTEM AND METHOD FOR AUTOMATICALLY OBTAINING A MILK SAMPLE AND PERFORMING CLEANING

(75) Inventor: Leif Johannesson, Tullinge (SE)

(73) Assignee: DELAVAL HOLDING AB, Tumba (SE)

(21) Appl. No.: 13/054,613

(22) PCT Filed: Jul. 10, 2009
(86) PCT No.: PCT/EP2009/058853

§ 371 Date: Jan. 18, 2011

(30) Foreign Application Priority Data
Jul. 17, 2008 (SE) 0801706-3

(51) Int. Cl. A01J 5/00

(52) U.S. Cl. 119/14.18; 901/30

(57) ABSTRACT

A system (10) operable to automatically obtain a milk sample and to automatically perform cleaning includes a milking arrangement (12) adapted for the milking of animals (14); a milk conduit (38); a cleaning supply conduit (56) which includes a cleaning device (82) adapted to supply cleaning liquid to the milking location (16), to the teat cups (18) of the milking location (16), to the milk conduit (38) during the cleaning; and a sampling arrangement. The sampling arrangement including an intermediate sampling device (24); a diverting part (22) operable to divert milk from the teat cups (18) to the intermediate sampling device (24); and a milk sample collecting element (64) for the milking location (16), operable to obtain a milk sample from the intermediate sampling device (24). The system (10) is adapted to apply a suction pressure during the cleaning, in order to draw the cleaning liquid through both the milking arrangement (12), including the teat cups, and the sampling arrangement.

### FIELD OF THE INVENTION

The present invention relates, in a first aspect, to a system operable to automatically obtain a milk sample and to automatically perform cleaning.

According to a second aspect, the present invention relates to a method for automatically obtaining a milk sample and automatically performing cleaning.

According to a third aspect, the present invention relates to at least one computer program product for automatically obtaining a milk sample and automatically performing cleaning.

### BACKGROUND OF THE INVENTION

The patent document DE-3502858 relates to a device for drawing off milk samples from the delivery line, which device is used to divert milk into the sample flask by means of clocked pulses. The object with this solution is to achieve, by means of the above mentioned device a representative, virtually carry-over-free sample even if the delivery rate changes during a sampling operation. The representativity of the sample is achieved by the flow rate in the delivery line being measured continuously and a microprocessor each time calculating, from the data, stored prior to the start of the milk delivery, comprising amount of milk, sample flask filling volume, amount of sample diverted per pulse, and pipeline cross-section area, and from the flow rate measured in each case, the interval time between two diverting pulses, so that per approximately equal amount of milk which flow through the line a portion is diverted in the sample flask. At the end of the delivery process the sample flask then contains the required filling volume. The carry-over of milk from a previous sampling operation into the next sample is prevented by briefly actuating the sample diversion automatically, as soon as the delivery line is filled with milk, in order to flush the milk diversion path free of any adhering milk residues and by passing the flushing milk not into the sample flask but discharging it.

The patent document CA-A1-2,424,629 relates to an on-line sampling device for IR milk analysis. A proportion liquid sampling on-line device uses a frusto-conically-shaped deflector positioned in a sampling chamber. The deflector reverses twice the main flow incidence by 180° and generates a film of flowing liquid substantially bubble-free. A secondary flow containing a predetermined quantity of liquid is diverted from the main flow and compacted in a measurement attachment to create slabs of liquid with no entrained air. The device comprises a slot, the dimensions of which are selected so as to divert always a given amount of liquid, e.g. 1.5% of the main flow, irrespective of the main flow velocity or accelerations. Advantageously, these slabs of liquid are similar to a microscope slide and provide for an optimal IR sensing.

The patent document WO-A1-01/43534 relates to teat cup cleaning in an automated milking system comprising a plurality of teat cups, each connected to a first end of a respective milk line, and the second end of each milk line being individually and automatically connectable to a first or a second container, respectively, wherein, during milking of the teats of a milking animal, the plurality of teat cups are attached to the teats of the animal, the second ends of the milk lines are connected to said first container and vacuum is supplied to said first container in order to draw milk through the milk lines into said first container. The cleaning comprises supplying a cleaning fluid to at least a first of said plurality of teat cups; connecting the second end of the milk line connected to the first teat cup to said second container; and supplying vacuum to said second container in order to suck cleaning fluid through the milk lines into said second container, while keeping said first container at substantially atmospheric pressure.

A main disadvantage with the above mentioned solutions are that they only present a partial solution to the problem of automatically obtaining a representative milk sample, and automatically perform cleaning in place.

### SUMMARY OF THE INVENTION

The above mentioned problems are solved by a system operable to automatically obtain a milk sample, and to automatically perform cleaning according to Claim 1. The system comprises a milking arrangement and a sampling arrangement. The milking arrangement is adapted for milking of animals, and comprises teat cups for each milking location, a milk conduit, and a cleaning supply conduit. The cleaning supply conduit comprises a cleaning device arranged at the milking location and adapted to supply cleaning liquid. The sampling arrangement comprises a diverting means, an intermediated sampling device, and a milk sample collecting element for the milking location. The diverting means is operable to divert milk from the teat cups to the intermediate sampling device. The milk sample collecting element is operable to obtain a milk sample from the intermediate sampling device. The teat cups are connected to the cleaning device and the milk conduit during the cleaning. The system is adapted to apply a suction pressure, during the cleaning, in order to draw the cleaning liquid through both the milking arrangement and the sampling arrangement of the system.

A main advantage with the system according to the present invention is that both cleaning and obtaining a milk sample is performed automatically with the same system.

Another advantage with the system according to the present invention is that every part of the system which has been in contact with the milk is cleaned automatically during the cleaning.

A further advantage in this context is achieved if said intermediate sampling device comprises a measuring means operable to measure the amount of milk in said intermediate sampling device. Hereby, said intermediate sampling device is able to work as a milk meter.

Furthermore, it is an advantage in this context if said diverting means is arranged to continuously divert a portion of the milk extracted via said teat cups. Hereby, a representative milk sample can be obtained automatically.

A further advantage in this context is achieved if said system also comprises a conduit connected between said diverting means, and said intermediate sampling device, and arranged to secure pressure equalizing between said milk conduit, and said intermediate sampling device. Hereby, the function of the intermediate sampling device as a milk meter is secured.

Furthermore, it is an advantage in this context if said system also comprises an air injector operable to supply air to said cleaning liquid so that a liquid slug is created that flushes said milking arrangement and/or said sampling arrangement. Hereby, the cleaning efficiency is enhanced.

The above mentioned problems are also solved with a method for automatically obtaining a milk sample and automatically performing cleaning according to Claim 11. The method is performed with the aid of a system comprising a milking arrangement, and a sampling arrangement. The milking arrangement is adapted for milking of animals, and comprises teat cups for each milking location. The method comprises the steps:
to apply said teat cups on an animal to be milked;
to apply suction pressure to said milking arrangement in order to extract milk;
to apply a pressure in an intermediate sampling device comprised in said sampling arrangement;
with the aid of a diverting means comprised in said sampling arrangement, to divert milk from said teat cups to said intermediate sampling device;
with the aid of a milk sample collecting element comprised in said sampling arrangement for each intermediate sampling device, to obtain a milk sample from said intermediate sampling device;
with the aid of a cleaning supply conduit comprising a cleaning device arranged at said milking location, and comprised in said milking arrangement, to supply cleaning liquid, said teat cups being connected to said cleaning device, and said milk conduit; and
with the aid of said system, to apply a suction pressure, during said cleaning, in order to draw said cleaning liquid through both said milking arrangement, and said sampling arrangement of said system.

A main advantage with the method according to the present invention is that both cleaning and obtaining a milk sample is performed automatically with the same method.

Another advantage with the method according to the present invention is that every part of the system which has been in contact with the milk is cleaned automatically during the cleaning.

A further advantage in this context is achieved if said method also comprises the step:
with the aid of an air injector comprised in said system, to supply air to said cleaning liquid so that a liquid slug is created that flushes said milking arrangement and/or said sampling arrangement. Hereby, the cleaning efficiency is enhanced.

The above mentioned problems can also be solved by at least one computer program product according to Claim 17. The at least one computer program product is/are directly loadable into the internal memory of at least one digital computer. The at least one computer program product comprises software code portions for performing the steps of the method according the present invention, when the at least one product is/are run on the at least one computer.

A main advantage with the at least one computer program product according to the present invention is that both cleaning and obtaining a milk sample is performed automatically with the same product/products.

Another advantage with the at least one computer program product according to the present invention is that every part of the system which has been in contact with the milk is cleaned automatically during the cleaning.

It will be noted that the term “comprises/comprising” as used in this description is intended to denote the presence of a given characteristic, step or component, without excluding the presence of one or more other characteristic features, integers, steps, components or groups thereof.

Embodiments of the invention will now be described with a reference of the accompanying drawings, in which:

### BRIEF DESCRIPTION OF THE DRAWINGS

FIG. 1 is a block diagram of a system operable to automatically obtain a milk sample and to automatically perform cleaning according to the present invention;

FIG. 2 shows schematically a part of said system disclosed in FIG. 1 in more detail;

FIG. 3 is a cross section view of a first embodiment of a diverting means comprised in the system according to the present invention;

FIG. 4 shows schematically a second embodiment of a diverting means comprised in the system according to the present invention;

FIG. 5 is a flow chart of the method for automatically obtaining a milk sample, and automatically performing cleaning according to the present invention;

FIG. 6 shows schematically a rotary herringbone parlour, wherein the system according to the present invention can be used;

FIG. 7 shows schematically a rotary parlour, wherein the system according to the present invention can be used;

FIG. 8 shows schematically a herringbone parlour, wherein the system according to the present invention can be used;

FIG. 9 shows schematically a parallel parlour, wherein the system according to the present invention can be used; and

FIG. 10 schematically shows a number of computer program products according to the present invention.

### DETAILED DESCRIPTION OF EMBODIMENTS

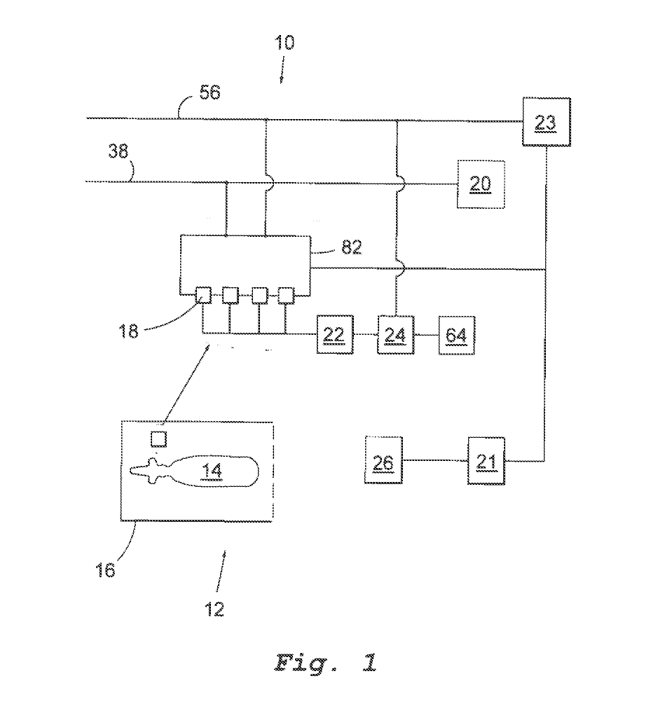

In FIG. 1 there is disclosed a system 10 operable to automatically obtain a milk sample, and to automatically perform cleaning according to the present invention. The system 10 comprises a milking arrangement 12, and a sampling arrangement. The milking arrangement 12 is adapted for milking of animals 14, and comprises teat cups 18 for each milking location 16, a milk conduit 38, and a cleaning supply conduit 56. The cleaning supply conduit 56 comprises a cleaning device 82 arranged at the milking location 16, and is adapted to supply cleaning liquid. The sampling arrangement comprises a diverting means 22, an intermediate sampling device 24, and a milk sample collecting element 64 for the milking location 16. The diverting means 22 is operable to divert milk from the teat cups 18 to the intermediate sampling device 24. The milk sample collecting element 64 is operable to obtain a milk sample from the intermediate sampling device 24. During cleaning the teat cups 18 are connected to the cleaning device 82 and the milk conduit 38. The system 10 is adapted to apply a suction pressure, during the cleaning, in order to draw the cleaning liquid through both the milking arrangement 12, and the sampling arrangement of the system 10.

The system 10 may also comprise a robot 26 operable to position the teat cups 18 on the animal 14 in the milking location 16. The robot 26 is only disclosed schematically.

Also disclosed in FIG. 1 is a central milk tank 20 connected to the milk conduit 38. It is pointed out that the central milk tank 20 is not a part of the system 10.

Also disclosed in FIG. 1 is a control means 21 connected to the robot 26, and to a tank 23 with cleaning liquid. The tank 23 with cleaning liquid is also connected to the supply conduit 56. It is pointed out that neither the control means 21 nor the tank 23 is part of the system 10 according to the present invention.

According to one embodiment of the system 10, the milk sample collecting element 64 is a disposable milk sample collecting element 64.

With the system 10 disclosed in FIG. 1 the cleaning liquid is drawn to the intermediate sampling device 24 directly from the cleaning supply conduit 56, or via the cleaning device 82, or both of them.

According to one embodiment of the system 10, the diverting means 22 is arranged to continuously divert a portion of the milk extracted via the teat cups 18. Hereby, a representative milk sample can be obtained automatically.

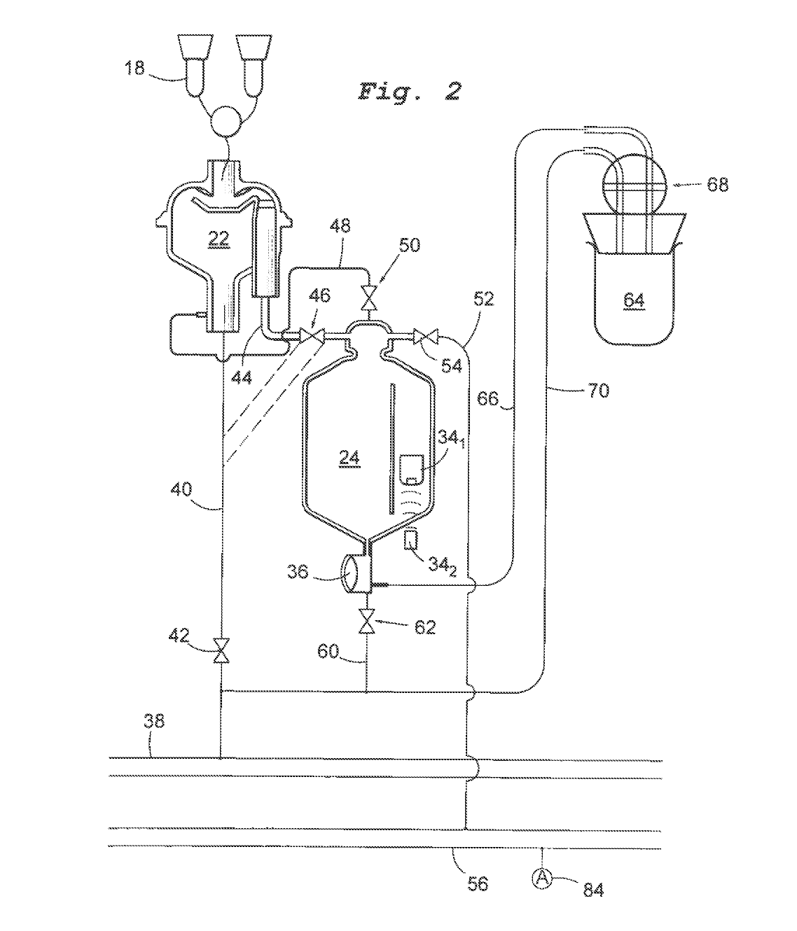

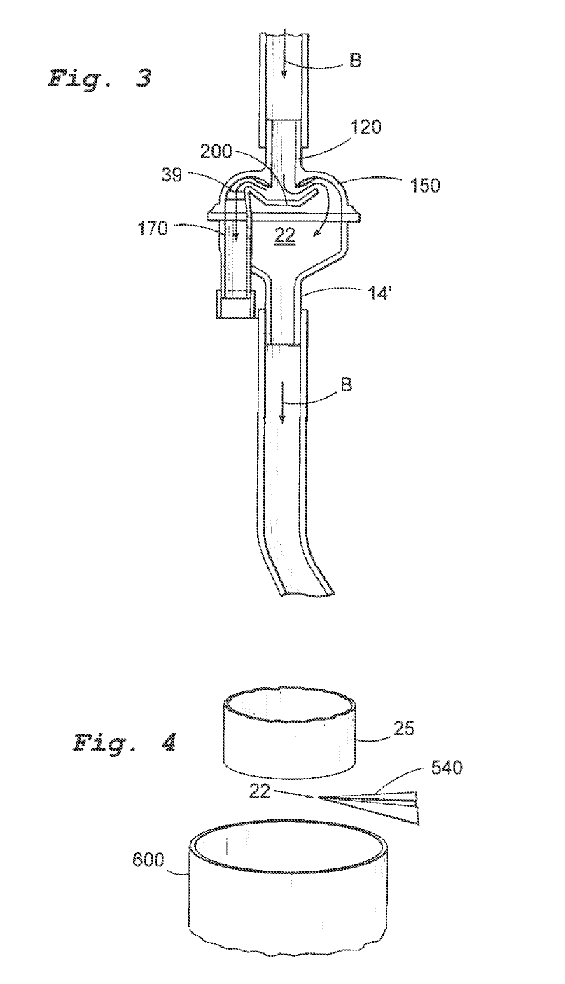

In FIG. 2 there is schematically disclosed a part of the system 10 disclosed in FIG. 1 in more detail. Although not disclosed in FIG. 2, the teat cups 18 are supposed to be connected to the teats of an animal 14 (see FIG. 1). The teat cups 18 are connected to the diverting means 22, which will be described in more detail in connection with FIGS. 3 and 4. Elements of the system 10 disclosed in both FIGS. 1 and 2 are designated with similar reference signs.

Herein below follows a description of how the system 10 works, when automatically obtaining a milk sample, or when automatically performing cleaning, in connection to FIG. 2. It is pointed out that the solution disclosed in FIG. 2 is just one possible way of implementing the system 10 according to the present invention.

The automatic obtaining of a milk sample is made possible by connecting the intermediate sampling device 24 to atmospheric pressure, which e.g. can be achieved by connecting the intermediate sampling device 24 to the cleaning supply conduit 56 via a conduit 52 when the valve 54 is in the open condition. When milk is to be transported to the milk sample collecting element 64 the valve 62 is closed, there is vacuum in the milk sample collecting element 64 as it is connected to the vacuum in the milk conduit 38 via the conduit 70. The milk is then drawn to the milk sample collecting element 64 via the conduit 66. If the intermediate sampling device 24 is provided with a measuring means 34 operable to measure the amount of milk in the intermediate sampling device 24 and the volume of the milk sample collecting element 64 is known, and also the dimensions of the conduit 66, it is possible to calculate for how long time the valve 54 shall be open to fill the milk sample collecting element 64 with milk. The measuring means 34 can e.g. comprise, as in FIG. 2, a float gauge 34, arranged inside the intermediate sampling device 24, and a transmitter 34₂ arranged outside of the intermediate sampling device 24 It is of course possible to fill the milk sample collecting element 64 without a measuring means provided in the intermediate sampling device 24 by letting the milk be drawn through the conduit 66 during enough time to ensure filling of the milk sample collecting element 64. Superfluous milk is drawn via the conduit 70 and further through the milk conduit 38.

During milking there is atmospheric pressure in the cleaning supply conduit 56, and one advantage with connecting the intermediate sampling device 24 to the cleaning supply conduit 56 in order to achieve atmospheric pressure in the intermediate sampling device 24 is that clean air is present in the cleaning supply conduit 56. Of course it is possible to achieve atmospheric pressure in another way, but the connection between the intermediate sampling device 24 and the cleaning supply conduit 56 is necessary in order to achieve automatic cleaning of the sampling arrangement.

During milking both the valves 62 and 54 are closed, but the valve 46 in the conduit 44 is open. Milking vacuum is present in the intermediate sampling device 24 via the conduit 44.

During milking there is created slugs of milk. A problem with this is that the part of the slug which is transported via the conduit 44 can fill the whole cross section of the conduit 44. Hereby, the vacuum level in the intermediate sampling device 24 gets temporary lower and the next milk slug to be diverted by the diverting means 22 is drawn via the conduit 40 to the milk conduit 38. If this occurs, the function of the intermediate sampling device 24 as a milk meter will become impaired. In order to have milk drawn to the intermediate sampling device 24, there has to be similar pressure in the intermediate sampling device 24 as in the milk conduit 38. This is achieved with the conduit 48, a so called vacuum supply conduit. The conduit 48 is also provided with a valve 50, which during milking should be open.

The milk diverted into the intermediate sampling device 24 during milking, is diverted tangentially into the intermediate sampling device 24 at its upper part. If milk is filling the whole cross section of the conduit 44 despite the presence of the vacuum supply conduit 48, the milk can be sucked to the milk conduit 38 via the conduit 48.

During cleaning the cleaning supply conduit 56 is supplied with cleaning liquid from a cleaning unit (not disclosed). In the milk conduit 38, which is empty of milk, there is vacuum. The cleaning supply conduit 56 is connected to the milk conduit 38 via the teat cups 18 which are connected to the cleaning supply conduit 56 via a cleaning device 82 (see FIG. 1). The cleaning liquid is drawn by the use of vacuum. The main flow of the cleaning liquid is drawn through the teat cups 18, the diverting means 22, the conduit 40 and the milk conduit 38.

When the valve 62 is open the intermediated sampling device 24 is connected to vacuum. Hereby, the cleaning liquid can be drawn from the cleaning supply conduit 56 via the conduit 52 on condition that the valve 54 is open, and into the intermediate sampling device 24.

The valves 46 and 50 can be open during all the time of the cleaning. The cleaning liquid can be drawn into the intermediate sampling device 24 via the conduit 44 when both the valves 46 and 62 are open.

When the milk sample collecting element 64 is to be cleaned, the valve 62 is firstly closed. The valve 46 in the conduit 44 and the valve 50 in the vacuum supply conduit 48 are both open. Hereby, the intermediate sampling device 24 can be filled with cleaning liquid via the conduit 44. Another alternative is to fill the intermediate sampling device 24 with cleaning liquid via the conduit 52 connected to the cleaning supply conduit 56. Thereafter, the valve 50 is closed, and the valve device 68 in connection to the milk sample collecting element 64 is opened. In the milk sample collecting element 64 there is vacuum due to the fact that it is in connection to the milk conduit 38 via the conduit 70. The cleaning liquid will be drawn from the intermediate sampling device 24 via the conduit 66 into the milk sample collecting element 64 and thereafter further through the conduit 70 and the milk conduit 38. In order to discharge the cleaning liquid from the milk sample collecting element 64, it can be turned upside down during cleaning, at least during the end of the cleaning. It is also possible to place a drain at the bottom of the sample container, or to also use air for drying.

It is important that the cleaning liquid also is drawn through the vacuum supply conduit 48 during cleaning. This can be performed by having both the valves 62 and 46 closed, at the same time as the valves 50, 54 and 42 are opened. Hereby, the cleaning liquid is drawn via the conduit 52 further on through the conduit 48 to the conduit 40 and finally further through the milk conduit 38.

During cleaning some of the valves are alternatively open and closed in order to secure that there is vacuum in the conduit and/or space that will be cleaned. Even the inlet to the intermediate sampling device 24 has to be cleaned properly in order to avoid growth of germs. The inlet to the intermediate sampling device 24 can be cleaned at the same time as the vacuum supply conduit 48 is cleaned. The inlet to the intermediate sampling device 24 can also be cleaned by having the valves 54, 46 and 42 open, and the valves 50, 62 and 68 closed. It is an advantage to let the cleaning liquid be drawn through different passages and through one passage at a time. Hereby, effective cleaning and enough flows are secured.

Also disclosed in FIG. 2 is an agitator means 36, which consists of a membrane, wherein one surface of the membrane is adjoin to the lower part of the intermediate sampling device 24 and the other surface is adjoin to a pulsating means. When there is vacuum in the intermediate sampling device 24 the membrane will pulsate and function as an agitator. The agitation function is an advantage both at cleaning and in order to obtain a representative milk sample, i.e. the milk is agitated in the intermediate sampling device 24 before it is connected to atmospheric pressure and a milk sample is drawn to the milk sample collecting element 64.

Also disclosed in FIG. 2 is an air injector 84, which is comprised in the system 10, and is operable to supply air to the cleaning liquid so that a liquid slug is created that flushes the milking arrangement 12 and/or the sampling arrangement.

In FIG. 3 there is disclosed a cross section view of a possible embodiment of a diverting means 22 comprised in the system 10 according to the present invention. The diverting means 22 comprises a dome-shaped upper section 150 and a funnel-shaped lower section 170. The upper section 150 receives milk through input port 120 from the teat cups 18 (see FIGS. 1 and 2). The diverting means 22 also comprises a deflector 200 which is centred inside the upper section 150 and attached to the upper section 150. The deflector 200 is used for re-directing a portion of the main flow into a slot 39. The dimension of the slot 39 is selected so as to divert always a given amount of milk, e.g. 3% of the main flow, arrow C, to the sample means 24. The rest of the main flow, e.g. 97%, arrow B, can e.g. be delivered to the milk conduit 38 (see FIG. 2).

In FIG. 4 there is schematically disclosed a second, possible embodiment of the diverting means 22 comprised in the system 10 according to the present invention. The diverting means 22 is arranged between the outlet 25 from the teat cups 18 (see FIG. 2) and the opening 600 of the line 40 (see FIG. 2) leading to e.g. the milk conduit 38. The diverting means 22 has the form of a point with a channel 540 which leads a representative milk sample to the intermediate sampling device 24 (see FIG. 2).

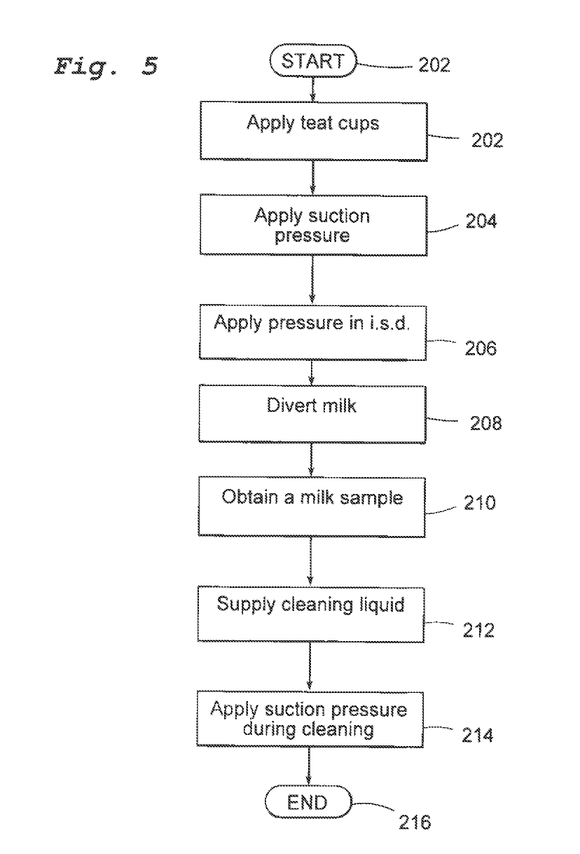

In FIG. 5 there is disclosed a flow chart of a method for automatically obtaining a milk sample and automatically perform cleaning according to the present invention. The method is performed with the aid of a system 10 (see FIG. 1) comprising a milking arrangement 12 and a sampling arrangement. The milking arrangement 12 is adapted for milking of animals 14, and comprises teat cups 18 for each milking lcoation 16. The method begins at block 200. Thereafter, the method continues, at block 202, with the step: to apply the teat cups 18 on an animal 14 to be milked. The method continues, at block 204, with the step: to apply suction pressure to the milking arrangement 12 in order to extract milk. Thereafter the method continues, at block 206, with the step: to apply a pressure in an intermediate sampling device 24 comprised in the sampling arrangement. The method continues, at block 208, with the step: with the aid of a diverting means 22 comprised in the sampling arrangement, to divert milk from the teat cups 18 to the intermediate sampling device 24. Thereafter, the method continues, at block 210, with the step: with the aid of a milk sample collecting element 64 comprised in the sampling arrangement for each intermediate sampling device 24, to obtain a milk sample from the intermediate sampling device 24. The method continues, at block 212, with the step: with the aid of a cleaning supply conduit 56 comprising a cleaning device 82 arranged at the milking location 16 and comprised in the milking arrangement 12, to supply cleaning liquid, the teat cups 18 being connected to the cleaning device 82 and the milk conduit 38. Thereafter, the method continues, at block 214, with the aid of the system 10, to apply a suction pressure, during the cleaning, in order to draw the cleaning liquid through both the milking arrangement 12 and the sampling arrangement of the system 10. The method is completed at block 216.

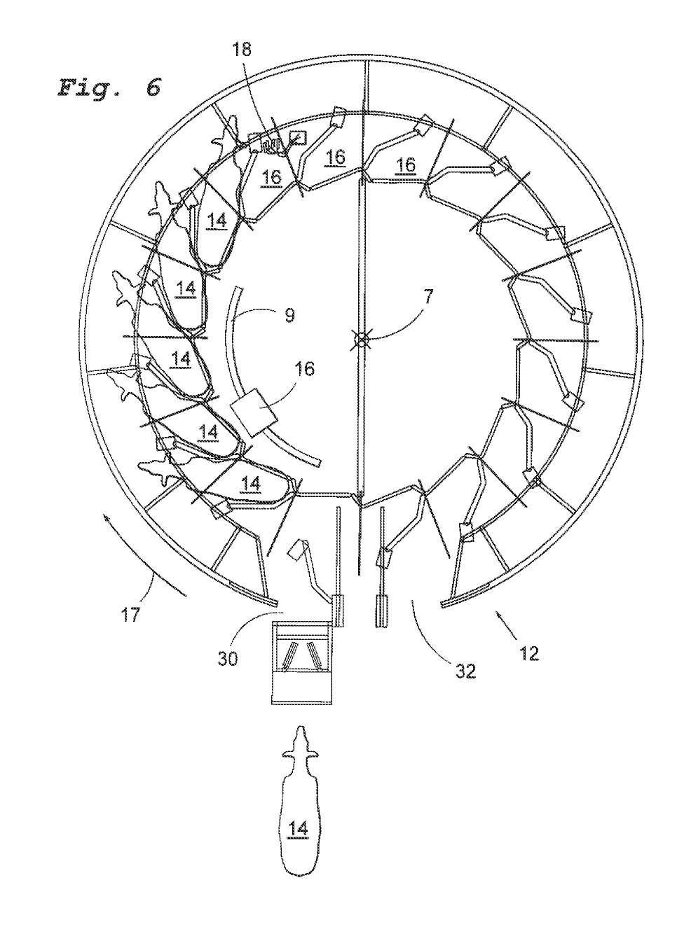

In FIG. 6 there is schematically disclosed a rotary herringbone parlour 12, having a number of milking locations 16 for e.g. cows 14 to be milked, which milking locations 16 are annularly arranged around a rotational axis 7. In FIG. 6 there is shown five cows 14 already located in the milking locations 16, and one cow 14 ready to enter the rotary herringbone parlour 12 via the entrance gate 30. The rotary herringbone parlour 12 also has an exit gate 32. A robot 26 is arranged between the milking locations 16 and the rotational axis 7. The robot 26 is movable along a rail 9, which defines an arc, and the robot 26 is arranged to arrange the teat cups 18 on the cows 14 in the milking locations 16. The rotary herringbone parlour 12 is rotated in the clockwise direction, as is indicated by the arrow 17.

In FIG. 7 there is schematically disclosed a rotary parlour, wherein the system 10 according to the present invention can be used. In this case, both the milking locations 16 and the cows 14 are arranged parallel to each other and radially.

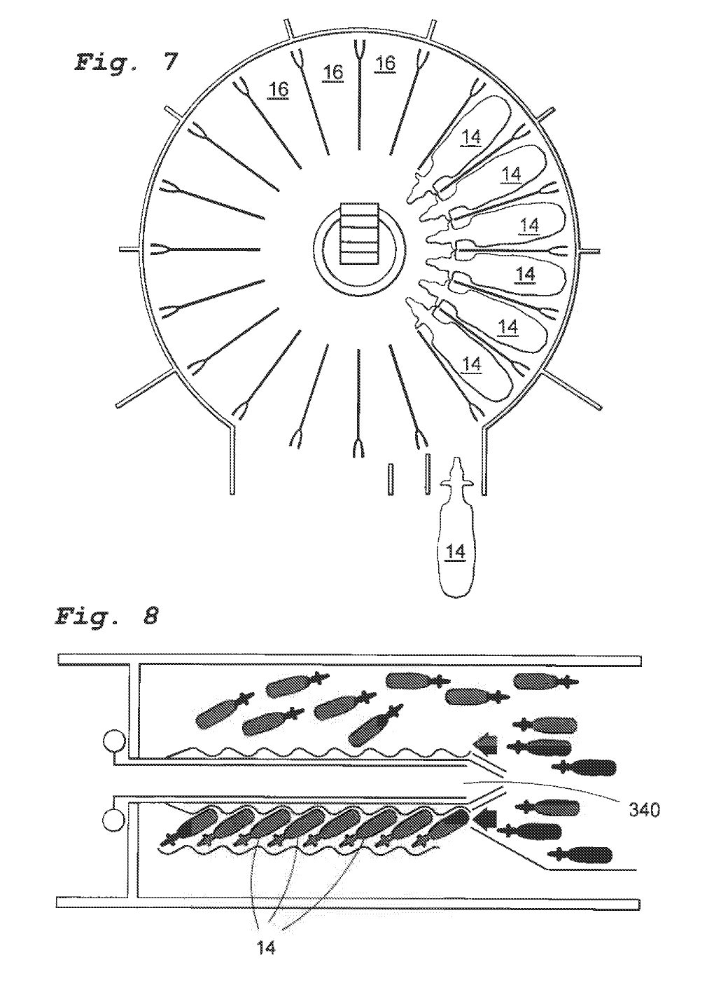

In FIG. 8 there is schematically disclosed a herringbone parlour, wherein the system 10 according to the present invention can be used. The cows 14 for milking are place side by side along a pit 340 in a herringbone configuration.

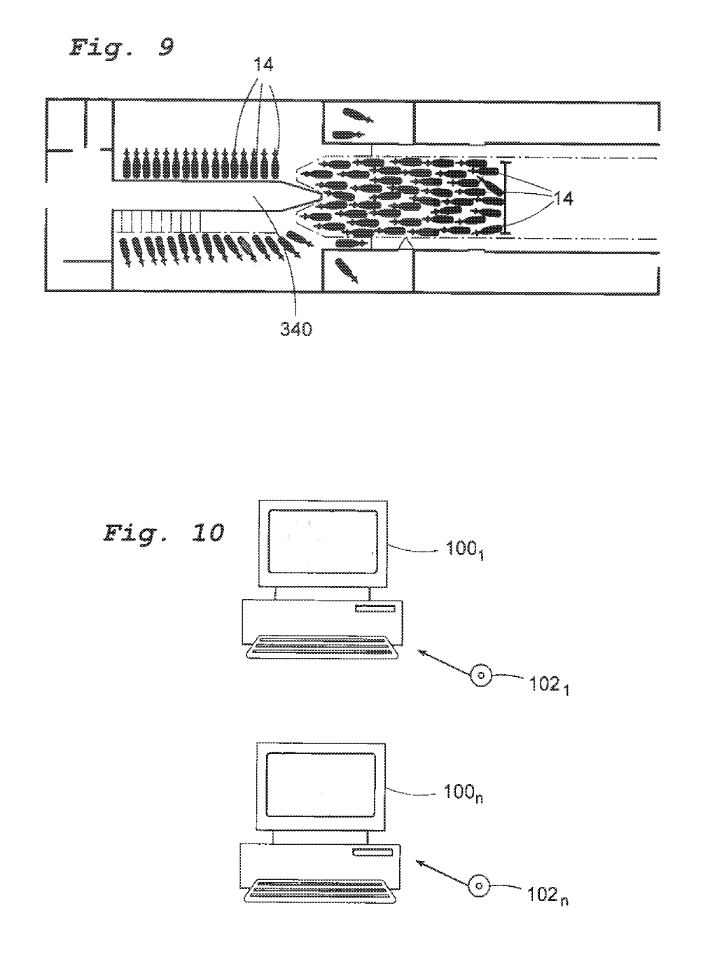

In FIG. 9 there is disclosed schematically a parallel parlour, wherein the system 10 according to the present invention can be used. In this case, the cows 14 for milking are placed parallel to each other along a pit 340. The cows 14 are arranged in a direction at right angles to the longitudinal direction of the pit 340.

In FIG. 10 there is disclosed a schematic diagram of some computer program products according to the present invention. There is disclosed n different digital computers 100₁, . . . , 100ₙ, wherein n is an integer. There is also disclosed n different computer program products 102₁, . . . , 102ₙ, here showed in the form of compact discs. The different computer program products 102₁, . . . , 102ₙ are directly loadable into the internal memory of the n different digital computers 100₁, . . . , 100ₙ. Each computer program product 102₁, . . . , 102ₙ comprises software code portions for performing some or all the steps of FIG. 5 when the product 102₁ . . . , 102ₙ is run on said computer(s) 100₁ . . . , 100ₙ. Said computer program products 102₁, . . . , 102ₙ can e. g. be in the form of floppy disks, RAM disks, magnetic tapes, opto magnetical disks or any other suitable products.

The invention is not limited to the embodiments described in the foregoing. It will be obvious that many different modifications are possible within the scope of the following claims.

1-17. (canceled)

18. A system (10) configured to automatically obtain a milk sample and to automatically perform system cleaning, the system (10) comprising:
a milking arrangement (12) adapted for milking of animals (14), the milking arrangement comprising teat cups (18) located at a milking location (16), a milk conduit (38), and a cleaning supply conduit (56),
the cleaning supply conduit (56) comprising a cleaning device (82) arranged at the milking location and adapted to supply a cleaning liquid; and
a sampling arrangement located at the milking location and comprising a diverting means (22) arranged to receive milk from the teat cups, an intermediate sampling device (24) located downstream of the diverting means, and a milk sample collecting element (64) located downstream of the intermediate sampling device,
the diverting means operable to divert a portion of the milk extracted from the animal by the teat cups to the intermediate sampling device and send another portion of the milk from the teat cups to the milk conduit,
the milk sample collecting element operable to obtain a milk sample from the intermediate sampling device,
wherein, during a cleaning operation, the cleaning system is configured for connection to the teat cups and, under suction, to draw the cleaning liquid from the cleaning supply conduit, via the teat cups, through the diverting means, through the intermediate sampling device, and through the milk conduit, in order to draw the cleaning liquid through both the milking arrangement and the sampling arrangement.

19. The system of claim 18, wherein said milk sample collecting element (64) is a disposable milk sample collecting element (64).

20. The system of claim 18, further comprising a robot (26) operable to position said teat cups (18) on said animals (14) at said milking location (16).

21. The system of claim 18, further comprising a line connecting said intermediate sampling device (24) directly to said cleaning supply conduit (56).

22. The system of claim 18, wherein said intermediate sampling device (24) comprises a measuring means (34) operable to measure an amount of milk in said intermediate sampling device (24).

23. The system of claim 22, wherein said measuring means (34) comprises a float gauge (34₁) arranged inside said intermediate sampling device (24), and a transmitter (34₂) arranged outside of said sampling device (24).

24. The system of claim 22, wherein said diverting means (22) is arranged to continuously divert the portion of the milk extracted via said teat cups (18) to the intermediate sampling device (24).

25. The system of claim 18, further comprising a conduit (48) connected between said diverting means (22) and said intermediate sampling device (24), said conduit arranged to secure pressure equalization between said milk conduit (38) and said intermediate sampling device (24).

26. The system of claim 18, wherein, during the cleaning operation, with said milk sample collecting element (64) connected to said intermediate sampling device (24), said cleaning liquid is drawn through said intermediate sampling device (24), said milk sample collecting element (64), and said milk conduit (38).

27. The system of claim 18, further comprising an air injector (84) operable to supply air to said cleaning liquid so that a liquid slug is created that flushes at least one of said milking arrangement (12) and said sampling arrangement.

28. A system (10) configured to automatically obtain a milk sample and to automatically perform system cleaning, the system (10) comprising:
a milking arrangement (12) adapted for milking of animals (14), the milking arrangement comprising teat cups (18), a milk conduit (38), and a cleaning supply conduit (56), the cleaning supply conduit (56) adapted to supply cleaning liquid; and
a sampling arrangement comprising a diverting means (22) arranged for receiving milk from the teat cups, an intermediate sampling device (24), and a milk sample collecting element (64),
the diverting means operable to divert a portion of the milk extracted from the teat cups to the intermediate sampling device and send another portion of the milk from the teat cups to the milk conduit,
the milk sample collecting element operable to obtain a milk sample from the intermediate sampling device,
wherein, during a cleaning operation, under suction, the cleaning liquid is drawn from the supply conduit, via the teat cups, through both the milking arrangement and the sampling arrangement.

29. A method for automatically obtaining a milk sample and automatically performing cleaning of a system (10) comprising a milking arrangement (12) and a sampling arrangement, the method comprising the steps of:
a) obtaining a milk sample by the steps of
applying teat cups (18) of a milking station on an animal (14) to be milked,
applying suction pressure to said milking arrangement (12) in order to extract milk from the animal via the teat cups,
applying a pressure in an intermediate sampling device (24) of the sampling arrangement,
diverting a portion of milk extracted from the animal, using a diverting means (22) of the sampling arrangement, to the intermediate sampling device,
providing a sample from the intermediate sampling device to a milk sample collecting element (64) of the sampling arrangement as the obtained milk sample; and
b) cleaning the system by the steps of
connecting a cleaning device (82) to the teat cups of the milking station, the cleaning device also being connected to a cleaning supply conduit (56) for supplying cleaning liquid, and
applying a suction pressure to draw the cleaning liquid through both said milking arrangement (12) and said sampling arrangement of said system (10).

30. The method of claim 29, wherein,
the milk sample collecting element (64) is a disposable milk sample collecting element (64), and
said method comprises the further step of replacing a used, disposable milk sample collecting element (64) with an unused, disposable milk sample collecting element (64).

31. The method of claim 29, wherein said step of applying the teat cups (18) is performed using a robot (26).

32. The method of claim 29, comprising the further step of drawing the cleaning liquid through the intermediate sampling device (24) directly from the cleaning supply conduit (56).

33. The method of claim 29, comprising the further steps of:
connecting the milk sample collecting element (64) to the intermediate sampling device (24); and
using the suction pressure, drawing the cleaning liquid through the intermediate sampling device (24), the milk sample collection element (64), and the milk conduit (38).

34. The method of claim 29, comprising the further step of using an air injector (84) to supply air to the cleaning liquid so that a liquid slug is created that flushes at least one of the milking arrangement (12) and the sampling arrangement.

35. The method of claim 34, performed from software code portions read from a non-transitory computer readable medium and loaded into an internal memory of a digital computer, the loaded software code portions causing the computer to execute said steps of obtaining a milk sample and cleaning the system.
